(19) United States
(12) Patent Application Publication
(10) Pub. No.: US 2006/0160604 A1
(43) Pub. Date: Jul. 20, 2006

(54) Game machine

(75) Inventor: Eiji Aida, Tokyo (JP)

Correspondence Address: GLOBAL IP COUNSELORS, LLP, 1233 20TH STREET, NW, SUITE 700, WASHINGTON, DC, 20036-2680, US

(73) Assignee: KONAMI CORPORATION, Tokyo (JP)

(21) Appl. No.: 11/160,419

(22) Filed: Jun. 23, 2005

(30) Foreign Application Priority Data
Jan. 17, 2005 (JP) 2005-009684

(51) Int. Cl. A63F 13/00

(52) U.S. Cl. 463/20

(57) ABSTRACT

A game machine of the present invention displays symbols aligned in parallel symbol sequences. There is a half-width overlap between the display regions of the adjacent symbol sequences. The perimeter or frame of each symbol forms a polygonal shape. After continually switching among the symbols displayed, the game machine executes a stop control under which the vertices of specific symbols match each other not only between two adjacent symbol sequences, but also between two symbol sequences that are separated by one symbol sequence. The adjacency of the symbols can be detected not only between the two adjacent symbol sequences, but also between the symbol sequences that are separated by one symbol sequence.

### BACKGROUND OF THE INVENTION

1. Field of the Invention

The present invention relates to a game machine which determines whether to award prizes according to the arrangement of a plurality of symbols.

2. Background Information

Game machines are known which display changing or stopping arrangements of symbols, and determine whether to award prizes according to the arrangement of the symbols. Included among them are game machines which feature symbol shapes, and game machines which have multilayer symbol sequences.

For example, Published Japanese Patent Application No. 2004-41264 discloses a game machine which has a display unit for displaying hexagonal symbols in a plurality of display regions, and which provides bonuses to players when the same symbols adjoin each other in a stopped arrangement displayed by the display unit. The display of the hexagonal symbols and the determination whether to award the prizes according to the adjacent relationship of the symbols provide novelty to the game and facilitate understanding of the game.

Japanese Patent No. 2641767 discloses a game machine which has a multilayer structure of a first symbol sequence and a second symbol sequence, and which changes the display of the first symbol sequence and then stops the change of the display in a display window. Furthermore, when the display shows that a specific symbol included in the first symbol sequence stops in the display window, the display of the second symbol sequence is changed at the display position of the specific symbol, and then a symbol included in the second symbol sequence stops at the display position. In this way, the display of the symbols is multi-layered, and thus, the symbol combinations have diversity without increasing reel installation space.

The technique disclosed in Published Japanese Patent Application No. 2004-41264 is characterized by its display structure, and is aimed at providing diversity to the modes of winning which exceeds the conventional concept of a prize winning line. The technique of this patent application detects the adjacency of the same symbols between adjacent symbol sequences and establishes the modes of winning when the same symbols adjoin each other, but does not detect the adjacency of symbols between two symbol sequences that are separated by a symbol sequence. Furthermore, even if the adjacency is detected, the hexagon-shaped symbols do not allow the verifiable display of the adjacency of the same symbols between two symbol sequences that are separated by a symbol sequence.

The technique disclosed in Japanese Patent No. 2641767 changes the display of specific symbols while stopping the change of the display of other symbols. More specifically, two symbol sequences are arranged so as to completely overlap, and the display of one symbol sequence is still changed after the display of the other symbol sequence has stopped, thereby providing diversity to the modes of winning. However, the symbol sequences visible to the player are arranged at the normal positions, and feature neither prize winning lines nor adjacency detection. For example, in a game machine which has three reels, the three reels appear arranged in parallel, and in a game machine with five reels, the five reels appear arranged in parallel, and the symbol sequences displayed never overlap. Accordingly, no prize winning lines are established and no adjacency is detected between two symbol sequences that are separated by a symbol sequence.

Thus, the conventional game machines award a prize when the same symbols of adjacent symbol sequences are aligned on a predetermined prize winning line. Accordingly, if the same symbols do not appear on any prize winning line when stopped adjacent symbol sequences are displayed, it is determined at that moment that no prizes can be awarded. As a result, the player may readily recognize that the possibility of winning a prize is zero even if there still are symbol sequences whose display continues to change.

In view of the above, there exists a need for a game machine which overcomes the above mentioned problems in the prior art. This invention addresses this need in the prior art as well as other needs, which will become apparent to those skilled in the art from this disclosure.

### SUMMARY OF THE INVENTION

An object of the present invention is to provide a game machine which can facilitate the display of the adjacency of symbols between two symbol sequences that are separated by a symbol sequence, thereby providing diversity to the modes of winning.

To attain this and other objects of the present invention, the game machine of the present invention determines whether to award a prize according to an arrangement of a plurality of symbols. The game machine comprises a display unit which displays a plurality of identical or different symbols; a start signal generating unit which generates a start signal; a display control unit that, when receiving the start signal, executes a change control which continually switches the plurality of symbols displayed on the display unit, and thereafter, executes a stop control which stops the change control; and an award determination unit which, having received the start signal, determines whether or not to award at least one predetermined prize. The plurality of symbols are aligned in parallel symbol sequences. There is a half-width overlap between the display regions of adjacent symbol sequences. The perimeter or frame of each of the plurality of symbols forms a polygonal shape. When the award determination unit determines that the at least one predetermined prize is to be awarded, the display control unit executes a first stop control and/or a second stop control. In the first stop control, the edges of the polygonal perimeters or frames of specific symbols included in two adjacent symbol sequences are matched with each other. In the second stop control, the vertices of their polygonal perimeters or frames of specific symbols included in two symbol sequences that are separated by one symbol sequence are matched with each other.

The game machine performs a stop control in order to match the vertices between specific symbols included in the two symbol sequences that are separated by one symbol sequence. Thereby, the adjacency of the symbols can be detected between the symbol sequences that are separated by one symbol sequence, and accordingly, the winning modes achieve diversity without adhering to the concept of a prize winning line. As a result, the symbols can be configured as winning combinations between the symbol sequences that are separated by one symbol sequence, even when the symbol arrangement does not include any winning combination between the adjacent symbol sequences whose display stops changing. Accordingly, there remains a possibility of winning at that point in time, and therefore, the number of instances where the possibility of winning is zero is reduced even if there are symbol sequences remaining whose display continues to change.

Furthermore, there is an increase in variations of winning combinations which link symbols in winning formation, thereby increasing the diversity of the game itself. In addition, there is a half-width overlap between the display regions of the adjacent symbol sequences, and therefore, diverse games can be realized without increasing the display space.

Preferably, the game machine of the invention further comprises a random number generating unit which, when receiving the start signal, generates a random number or a combination of random numbers, and a storage unit which stores an award determination table. The award determination table establishes correspondences between the random number or the combination of random numbers and the award of the at least one predetermined prize. In particular, the award determination unit determines whether or not to award the at least one prize by referencing the random number or the combination of random numbers generated by the random number generating unit in the award determination table.

In this way, the above-described game machines can facilitate the processes of diverse games by electrical controls, because the game machine determines whether or not to award prizes by referencing the generated random numbers in the award determination table.

Preferably, in the game machine of the present invention, the specific symbols included in the two symbol sequences are the same symbols.

Thus, the player can visually or intuitively comprehend a win since the win is established by the adjacency of the same symbols. In other words, the game machine can provide an easy-to-understand display to the player.

Preferably, in the game machine of the present invention, the polygonal shape of the perimeter or frame of each of the plurality of symbols is a rhombus, and the direction of a diagonal line of the rhombus matches the direction of the symbol sequence.

This allows the first stop control, under which the edges of the rhombuses match each other between the two adjacent symbol sequences, and allows the second stop control, under which the vertices of the rhombuses match each other between the two symbol sequences that are separated by one symbol sequence. Accordingly, the symbols are displayed in readily recognizable shapes for the player. In addition, there is an increase in the variations of winning combinations linking the symbols in winning formation, and the diversity of the game itself is increased.

Preferably, in the game machine of the present invention, the polygonal shape of the perimeter or frame of each of the plurality of symbols is an isosceles triangle, and the direction of the bisector of the apex angle of the isosceles triangle matches the direction of the symbol sequence.

This allows the first stop control, under which the edges of the isosceles triangles match each other between the two adjacent symbol sequences, and allows the second stop control, under which the vertices of the isosceles triangles match each other between the two symbol sequences that are separated by one symbol sequence. Accordingly, the symbols are displayed in readily recognizable shapes for the player. In addition, there is an increase in the variations of winning combinations linking the symbols in winning formation, and the diversity of the game itself is increased.

Preferably, in the game machine of the present invention, the plurality of symbols are arranged on a plurality of parallel mechanical reels, thereby composing the symbol sequences. The adjacent mechanical reels mutually overlap by half the width of each mechanical reel, and thereby the display regions of adjacent symbol sequences mutually overlap by half the width of the display regions.

In this way, the structure of the mechanical reels realizes the half-width overlap between the display regions of the adjacent symbol sequences, and accordingly, the player can see the mechanical actions of the mutually overlaid mechanical reels. This three-dimensional action can encourage the player's interest.

Preferably, the game machine of the present invention further comprises a storage unit in which symbol arrangement data of the symbol sequences is stored. The display control unit reads the symbol arrangement data from the storage unit, and uses the data in order to perform the change control and the first and second stop controls over the plurality of symbols.

In this way, the change control and the first and second stop controls over the symbols are performed by using the symbol arrangement data, or so-called video reels. Accordingly, mechanical controls are unnecessary, and therefore, the design of the display unit is simple. Furthermore, the maintenance and the like required for mechanical controls is also unnecessary.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of a game machine of the present invention;

FIG. 2 shows the electrical configuration of the main portion of the game machine;

FIG. 3 is an example of the display of the game machine during stop control according to a first embodiment of the present invention;

FIG. 4 shows patterns of winning symbol combinations in the display of the first embodiment;

FIG. 5 is an example of the display of the first embodiment during change control;

FIG. 6 is a flow chart showing the characteristic operation of the game machine of the present invention;

FIG. 7 is an example of the display during stop control according to a second embodiment of the present invention;

FIG. 8 is an example of the display of the second embodiment during change control;

FIG. 9 is another example of the display of the second embodiment during stop control;

FIG. 10 is an example of the display of a third embodiment of the present invention during stop control;

FIG. 11 is a general perspective view of a reel unit according to a fourth embodiment of the present invention;

FIG. 12 is a general cross-sectional view of the reel unit of the fourth embodiment; and

FIG. 13 is a general perspective view of another reel of the reel unit of the fourth embodiment.

### DETAILED DESCRIPTION OF THE PREFERRED EMBODIMENTS

Embodiments of the present invention will be described below with reference to the figures.

### First Embodiment

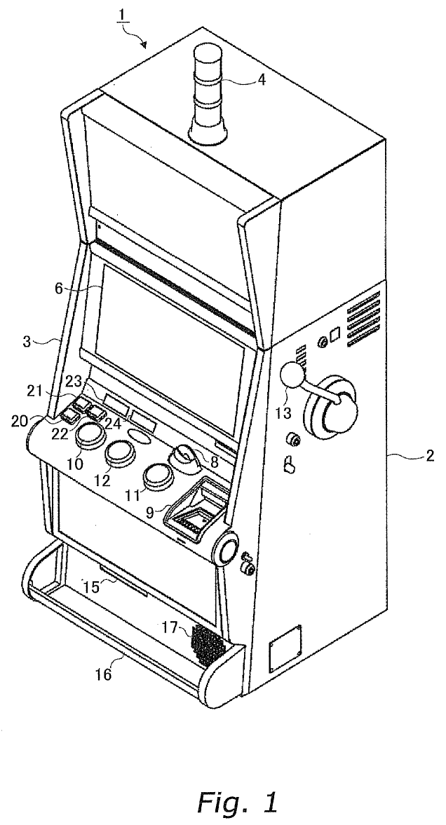

FIG. 1 is a perspective view of a game machine according to a first embodiment of the invention. As shown in FIG. 1, the game machine 1 includes a box 2 and a front panel 3. The front panel 3 is mounted on the front side of the box 2. A lamp 4 is provided at the top of the box 2. A screen 6 is provided behind the front panel 3.

For example, five symbol sequences are displayed on the screen 6, and the display of the symbol sequences changes in the sequence direction (or the vertical direction of the game machine), and thereafter, the display stops the change. Here, it is possible to change the display of various symbols and to stop the change of the display separately among in the symbol sequences.

A coin insertion slot 8 and a paper currency insertion slot 9 are provided on the front surface of the box 2. A bet button 10 is used to specify the number of coins to be bet. The coins are stored in (or “credited on”) a coin accumulation device (not shown in FIG. 1). A MAX bet button 11 is used to specify an acceptable maximum number of coins to be bet. A spin button 12 is used to start the change of the display on the screen 6. A spin lever 13 also has the same function.

On the screen 6, the information about the game operation methods and the game contents such as the symbol sequences are displayed. The screen 6 may be included in a display device capable of displaying the symbol sequences, such as a liquid crystal display, CRT, organic EL display, or the like. The game machine 1 is a so-called video reel game machine. Change control and stop control over the display of the symbols are performed by using so-called video reels. Accordingly, mechanical controls are unnecessary, and therefore, the design of the display unit is simple. Furthermore, the maintenance and the like required by mechanical controls is also unnecessary. A coin payout slot 15, a coin receiving tray 16, and a speaker 17 are provided below the front panel 3.

A pay-back button 20 is used to receive the coins stored. A change button 21 is used to light the lamp 4 on the top of the game machine 1 and thereby inform a person in charge of a change request. A help button 22 functions to display the rules of play, the amount of prizes, and the like, on the screen 6. A payout window 23 displays the number of the coins paid. A credit window 24 displays the number of the coins stored in the coin accumulation device. The payout window 23 and the credit window 24 use LEDs (light-emitting diodes), for example, or alternatively, may use liquid crystal displays.

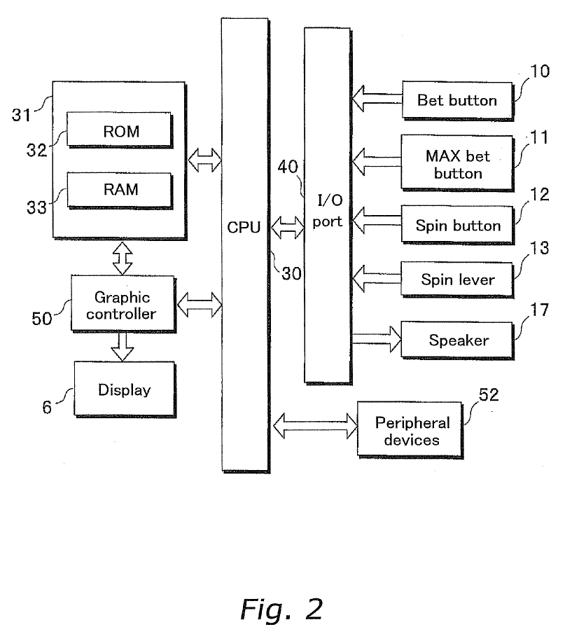

FIG. 2 is a block diagram showing the main portions of the electrical configuration of the game machine 1. As shown in FIG. 2, a CPU 30 uses a memory 31 including ROM 32 and RAM 33, and thereby performs control operations in accordance with predetermined programs. The CPU 30 functions as a random number generating unit which, when receiving a start signal, generates a random number or a combination of random numbers. The CPU 30 further functions as an award determination unit which reads the award determination table from the memory 31, and then determines whether or not to award prizes by referencing the generated random number or the combination of random numbers in the award determination table. This process is hereafter referred to as internal selection. The award determination table is a table which establishes correspondences between the random number or the combination of random numbers and the award of predetermined prizes. In this way, the game machine 1 can facilitate the processes of diverse games by electrical controls, since the game machine 1 determines whether or not to award prizes by referencing the generated random numbers in the award determination table.

The CPU 30 also functions as a display control unit which starts a change control for continuously switching among a plurality of symbols displayed on the screen 6, and thereafter executes a stop control for stopping the change control. The CPU 30, as the display control unit, performs the change control so that the display of the symbol sequences changes. After a predetermined amount of time has elapsed, the CPU 30, as the display control unit, performs the stop control so that the displays of the changing symbol sequences stop the changes in order, for example, in the order of the positions from left to right on the screen 6 at predetermined time intervals. The predetermined time may be fixed, or alternatively, may vary with every game. If a symbol combination which has been selected in an internal selection is displayed as a winning combination when the change of the display stops, the player receives a prize corresponding to the winning combination.

The CPU 30 executes control over the display of the symbol sequences, in which a plurality of symbols are arranged in parallel, so that the half-width overlap is realized between the display regions of the adjacent symbol sequences and the perimeter of each of the symbols forms a rhombus.

These functions are accomplished by executing programs. In addition to a control program for controlling the operation of the game machine 1, various types of visual effects programs, the award determination table, various types of data elements for use as image data elements, and symbol arrangement data of the symbol sequences, and the like are stored in the memory 31. Thus, the memory 31 functions as a memory unit and a storage unit.

The CPU 30 is connected through an I/O port 40 to the bet button 10, the MAX bet button 11, the spin button 12, the spin lever 13, and the speaker 17. Signals provided from the bet button 10 and the spin button 12 enter into the CPU 30 through the I/O port 40. The spin button 12 and the spin lever 13 function as start signal generators for generating a start signal.

The screen 6 reproduces image data provided from the CPU 30 through a graphic controller 50. The graphic controller 50 performs image processing and the like, and thereby characters, still images, video images, and the like are displayed on the screen 6. In this way, the screen 6 functions as a display unit.

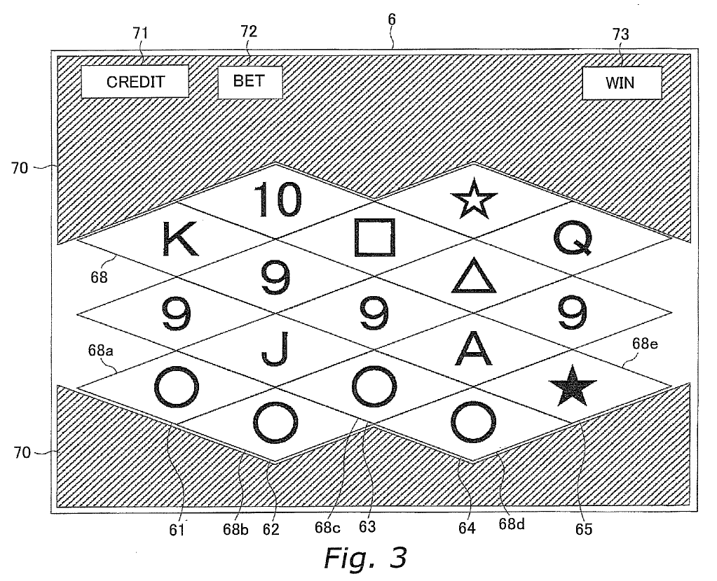

FIG. 3 shows an example of a display on the screen 6 when the change in the display of the symbols is stopped. As shown in FIG. 3, symbol sequences 61 through 65 are displayed on the screen 6. The first, third, and fifth symbol sequences 61, 63, and 65 are each composed of three rhombus-shaped symbols 68, and the second and fourth symbol sequences 62 and 64 are composed of four rhombus-shaped symbols 68. In each of the rhombus-shaped symbols 68 included in the respective symbol sequences 61 through 65, the direction of one diagonal of the rhombus matches the direction of the respective symbol sequences.

This allows a first stop control, under which the edges of the rhombus-shaped symbols 68 match each other between two adjacent symbol sequences (e.g., between the first and second symbol sequences 61 and 62), and further allows a second stop control, under which the vertices of the rhombus-shaped symbols 68 match each other between the two symbol sequences that are separated by one symbol sequence (e.g., between the first and third symbol sequences 61 and 63). Accordingly, the symbols are displayed in readily recognizable shapes for the player. In addition, there is an increase in the variations of winning combinations that link the symbols in winning formation, and the diversity of the game itself is increased.

A background 70 is displayed above and below the symbol sequences 61 through 65. In the upper left of the screen 6, a credited number 71 or the number of stored coins is displayed, and a bet number 72 or the number of coins bet is displayed. In the upper right of the screen 6, a payout number 73 or the number of coins awarded is displayed.

The game machine 1, when determining an award, displays common specific symbols adjoining each other on the screen 6. In the first embodiment, the “common specific symbol” refers to the same symbol or equivalent (i.e., a wild card symbol), or alternatively, may refer only to the same symbol. For example, if circle symbols adjoining each other are displayed, then the player understands that the same symbols adjoin each other in the display. “Wild card symbols” refer to the symbols which can be substituted for any symbol. “Adjacency” of the rhombus symbols 68 refers to the match of their edges between adjacent symbol sequences, and the match of their vertices between symbol sequences that are separated by one symbol sequence.

The game machine 1 performs stop control in order to match the vertices of specific symbols included in two symbol sequences that are separated by one symbol sequence. Thus, the adjacency of the symbols can be detected between symbol sequences that are separated by one symbol sequence, and accordingly, the winning modes will achieve diversity without adhering to the concept of a prize winning line. As a result, the symbols can be configured as winning combinations between symbol sequences that are separated by one symbol sequence, even when the symbol arrangement does not include any winning combination between the adjacent symbol sequences whose display stops changing. Accordingly, there remains a possibility of winning at that point in time, and therefore, the number of instances where the possibility of winning is zero is reduced even if there are still symbol sequences whose display continues to change. Furthermore, there is a half-width overlap between the display regions of the adjacent symbol sequences, and therefore, diverse games can be realized without increasing the display space.

For example, in FIG. 3, the bottom symbols 68a-68d of the first through fourth symbol sequences 61-64, respectively, are circle symbols which adjoin each other between the adjacent symbol sequences. The symbol 68e at the bottom of the fifth symbol sequence 65 is a wild card symbol (i.e., a star symbol) which adjoins the bottom symbol 68d of the fourth symbol sequence 64. Accordingly, in the example shown in FIG. 3, the display of the symbols 68a-68e shows a winning combination of symbols. Note that when the symbol 68e is a circle symbol instead of the wild card symbol, the display of the symbols 68a-68e shows an equivalent winning combination of the symbols.

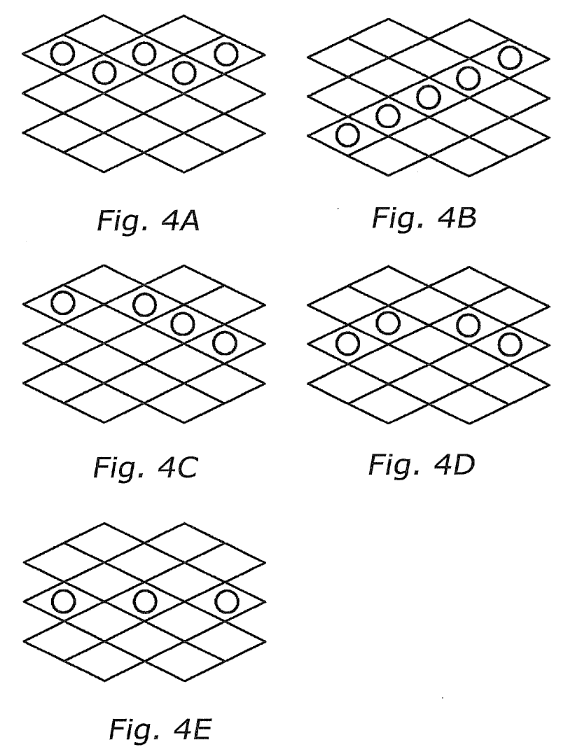

FIG. 4 shows schematic diagrams illustrating winning patterns. FIGS. 4A and 4B are examples of displays showing the adjacency of five circle symbols which result in a win. The display of other symbols is omitted. In this case, the edges of the adjoining symbols match each other between the adjacent symbol sequences. There are thirty-four adjacency patterns of five symbols depending on the positions of the adjoining symbols. In this case, the CPU 30 executes a first stop control, under which the edges on the perimeter of the symbols match each other between two adjacent symbol sequences, over the circle symbols which are present between the adjacent symbol sequences.

FIGS. 4C and 4D are examples of displays showing the adjacency of four circle symbols which results in a win. The display of other symbols is omitted. In this case, there are two places in which the edges of the adjoining symbols match each other between adjacent symbol sequences, and there is one place at which the vertices of the symbols match each other between two symbol sequences that are separated by one symbol sequence. There are thirty adjacency patterns of four symbols depending on the position of the adjoining symbols. In this case, the CPU 30 executes the first stop control over the circle symbols which are present between the adjacent symbol sequences. The CPU 30 also executes the second stop control, under which the vertices on the perimeters of symbols match each other between two symbol sequences that are separated by one symbol sequence, over the circle symbols which are present between the two symbol sequences that are separated by one symbol sequence.

FIG. 4E is an example of a display showing the adjacency of three circle symbols resulting in a win. The display of other symbols is omitted. In this case, there are no places at which the edges on the perimeters of the symbols match each other between adjacent symbol sequences, and there are two places at which the vertices on the perimeters of the symbols match each other between two symbol sequences that are separated by one symbol sequence. There are three adjacency patterns of the three symbols depending on the position of the adjoining symbols. In this case, the CPU 30 executes the second stop control over the circle symbols which are present between two symbol sequences that are separated by one symbol sequence.

Thus, in the game machine 1, there are a total of sixty-seven winning combinations of symbols. In a game machine which displays hexagonal symbols and the same numbers of symbols and symbol sequences as the numbers of those of the game machine 1, there are as many as thirty-four winning combinations of symbols. The game machine 1 achieves more variations of winning combinations using the same number of symbols, thereby increasing the diversity of the games.

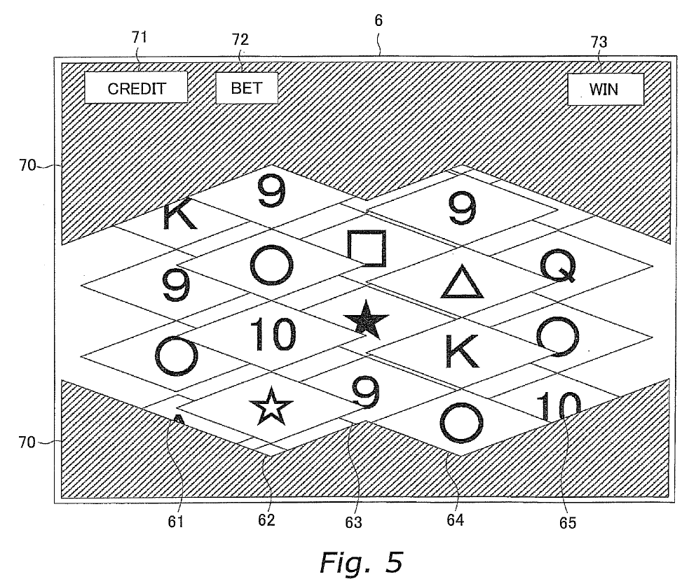

FIG. 5 is an example of the display on the screen 6 when the display of the symbols changes. As shown in FIG. 5, the symbols change from top to bottom just like the rotation of the mechanical reels on the surface of which the symbols are arranged in the symbol sequences 61-65. The second and fourth symbol sequences 62 and 64 are shown as if they are rotating outside of the first, third, and fifth symbol sequences 61, 63, and 65. The display of the symbols may alternatively change from bottom to top.

The speaker 17 reproduces sound data transmitted from the CPU 30 through the I/O port 40. The CPU 30 is connected to a peripheral device 52 which includes a hopper and the like, and controls them for coin payout using control signals.

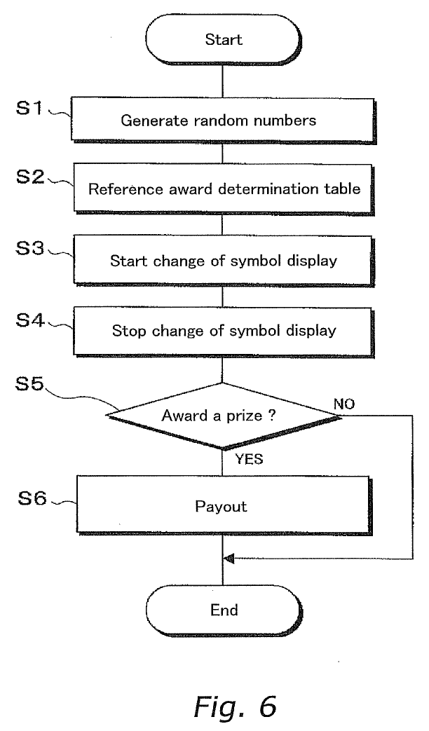

The following describes the operation of the game machine according to the first embodiment having the above-described configuration. FIG. 6 is a flow chart showing the characteristic operation of the game machine 1.

First, a game start operation, such as a player's bet, is accepted. The betting operation is accomplished by inserting a coin in the coin insertion slot 8, or betting a coin stored using the bet button 10. When the MAX bet button 11 is pressed, the acceptable maximum number of coins are bet. Combining these betting operations is also allowed. The game machine 1 awards prizes when the adjacency of symbols are displayed but does not when symbols are arranged on specific prize winning lines. Note that the criterion of adjacency detection may be modified in accordance with the number of the bets so that the number of instances where the adjacency is established increases in response to increases in number of the bets. Thereafter, the spin button 12 is pressed or the spin lever 13 is pulled, and then, a start signal is generated and the game is started.

The CPU 30, when receiving the start signal, generates a random number or a combination of random numbers (step S1). Then, the internal selection is performed, that is, the CPU 30 reads the award determination table from the memory 31 and determines whether or not to aware prizes while referencing the random number or the combination of random numbers in the award determination table (step S2). Next, on the screen 6, the display of the symbols starts changing by the change controls of the CPU 30 (step S3). At this time, the CPU 30 reads the data elements from the memory 31, forms an image data from the data elements, and reproduces the image data on the screen 6. After a predetermined time period has elapsed, the CPU 30 performs the stop control, thereby stopping the display of the symbols in each symbol sequences in turn (step S4).

Next, the CPU 30 determines whether or not to award prizes (step S5). If there is no prize to be awarded, the game is then finished. When a prize is to be awarded, an image indicating the award of the prize is displayed on the screen 6, and a payout is performed (step S6).

### Second Embodiment

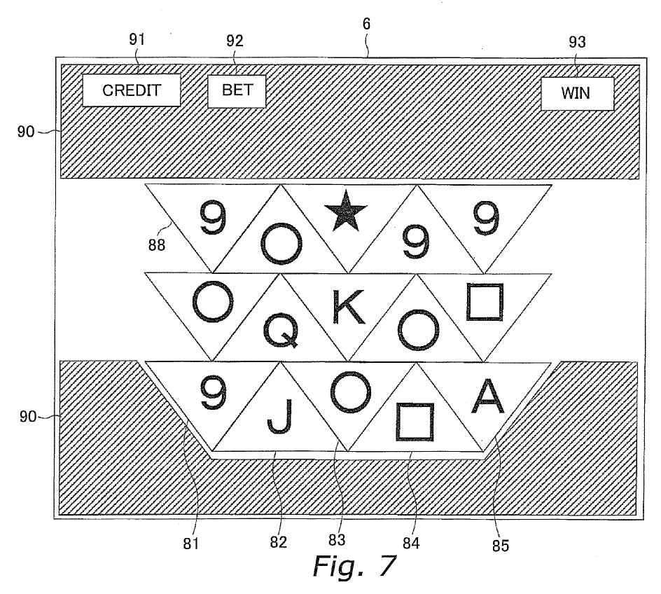

The perimeters of the symbols displayed on the screen 6 may be isosceles triangles, in contrast to the rhombuses in the first embodiment. FIG. 7 shows an example of the display on the screen 6 when the perimeters of the symbols are isosceles triangles. As shown in FIG. 7, symbol sequences 81 through 85 are displayed on the screen 6. All the symbol sequences 81-85 are composed of three symbols 88 which have a perimeter of an isosceles triangle. In the isosceles triangle-shaped symbols 88, the direction of the bisector of the apex angle of the isosceles triangle matches the direction of the symbol sequences. This allows a first stop control, under which the edges of the isosceles triangle-shaped symbols 88 match each other between two adjacent symbol sequences, and allows a second stop control, under which the vertices of the isosceles triangle-shaped symbols 88 match each other between two symbol sequences that are separated by one symbol sequence. Accordingly, the symbols are displayed in readily recognizable shapes for the player. In addition, there is an increase in variations of winning combinations linking the symbols in winning formation, and the diversity of the game itself is increased.

The triangular symbols 88 in the first, third, and fifth symbol sequences 81, 83, and 85 are opposite in vertical direction to the triangular symbols 88 in the second and fourth symbol sequences 82 and 84. A background 90 is displayed above and below the symbol sequences 81-85. In the upper left of the screen 6, a credited number 91 or the number of stored coins is displayed, and a bet number 92 or the number of coins bet is displayed. In the upper right of the screen 6, a payout number 93 or the number of coins awarded is displayed.

When an award is determined, common specific symbols adjoining each other are displayed on the screen 6. In the second embodiment, “adjacency” of the isosceles triangular symbols refers to the match of their edges between the adjacent symbol sequences, and the match of their vertices between the symbol sequences that are separated by one symbol sequence.

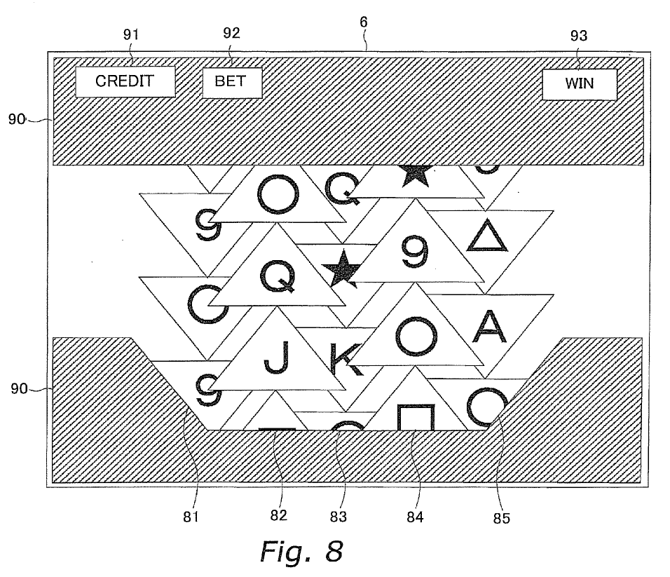

FIG. 8 shows an example of the display on the screen 6 when the display of the symbols changes. As shown in FIG. 8, the display of the symbols changes from top to bottom just like the rotation of the mechanical reels on the surface of which the symbols are arranged in the symbol sequences 81-85. The second and fourth symbol sequences 82 and 84 are shown as if rotating on the outside of the first, third, and fifth symbol sequences 81, 84, and 85.

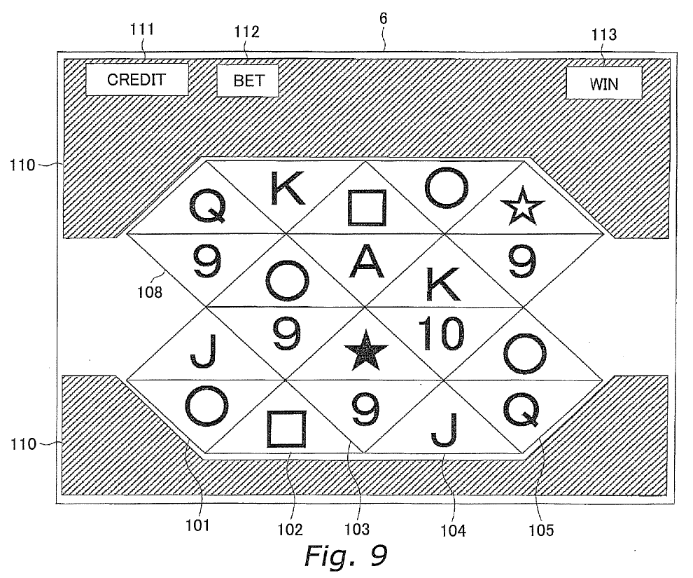

FIG. 9 shows another example of the display on the screen 6 when the perimeters of the symbols are isosceles triangles. This structure differs from the symbol layout of FIG. 7. As shown in FIG. 9, symbol sequences 101 through 105 are displayed on the screen 6. All the symbol sequences 101-105 are composed of four symbols 108 which have a perimeter of an isosceles triangle. The alternate isosceles triangle-shaped symbols 108 in each of the symbol sequences 101-105 are flipped from top and bottom. A background 110 is displayed above and below the symbol sequences 101-105. In the upper left of the screen 6, a credited number 111 or the number of coins stored is displayed, and a bet number 112 or the number of coins bet is displayed. In the upper right of the screen 6, a payout number 113 or the number of coins awarded is displayed. When an award is determined, the common specific symbols adjoining each other are displayed on the screen 6.

### Third Embodiment

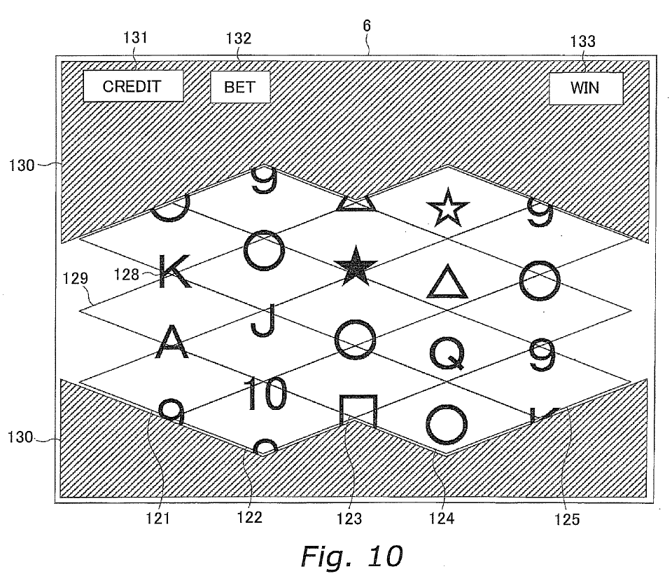

The frames of the symbols (which divide display areas of the symbols) may be fixed, and only the display of the bodies of the symbols, such as a circle symbol, a numerical symbol, or the like, may be changed, in contrast to the first embodiment where the rhombus-shaped perimeters of the symbols displayed on the screen change together with the bodies of the symbols in the screen. FIG. 10 shows an example of the display when only the bodies 128 of the symbols change and the frames 129 of the symbols are fixed. FIG. 10 is an example of the changing display. The display whose change has stopped is identical to that of the first embodiment.

As shown in FIG. 10, symbol sequences 121 through 125 are displayed on the screen 6. The bodies 128 of the symbols in each of the first, third, and fifth symbol sequences 121, 123, and 125 stop in the three rhombuses vertically arranged and divided by the frames 129. The bodies 128 of the symbols in each of the second and fourth symbol sequences 122 and 124 stop in four rhombuses vertically arranged and divided by the frames 129. A background 130 is displayed above and below the symbol sequences 121-125. In the upper left of the screen 6, a credited number 131 or the number of coins stored is displayed, and a bet number 132 or the number of coins bet is displayed. In the upper right of the screen 6, a payout number 133 or the number of coins awarded is displayed.

When an award is determined, the common specific symbols adjoining each other are displayed on the screen 6. “Adjacency” of the bodies of the symbols refers to the match of the edges of the rhombus-shaped frames in which the bodies of the common specific symbols stop between the adjacent symbol sequences, and the match of the vertices of the rhombus-shaped frames in which the bodies of the common specific symbols between the symbol sequences that are separated by one symbol sequence.

### Fourth Embodiment

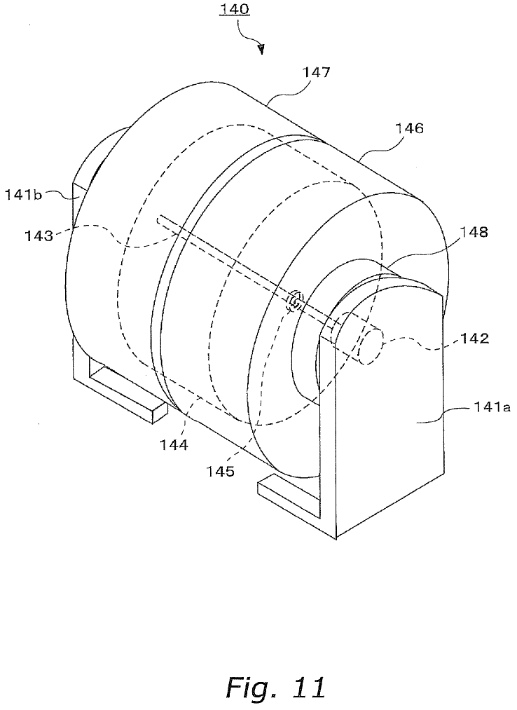

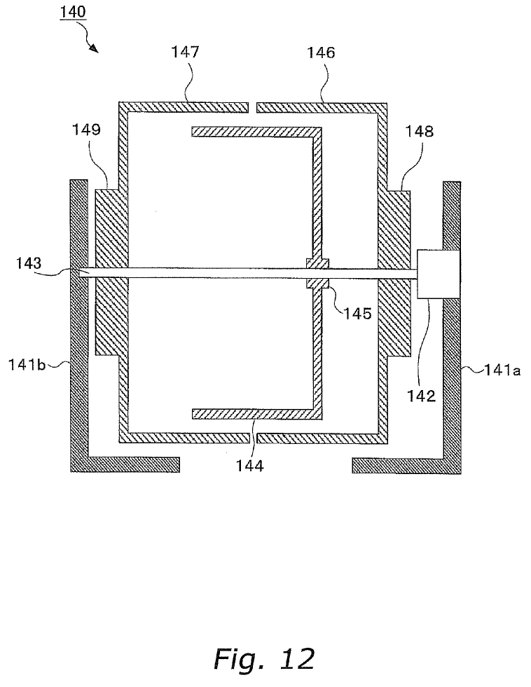

A game machine may use real, mechanical reels, in contrast to the display of a so-called video reel game machine in the first embodiment. FIG. 11 is a general perspective view of a reel unit 140 of a game machine using mechanical reels. FIG. 12 is a general cross-sectional view of the reel unit 140.

As shown in FIG. 11, the reel unit 140 comprises supports 141a and 141b, a stepping motor 142 for an inner reel, a shaft 143, an inner reel 144, and outer reels 146 and 147. The stepping motor 142 is fixed on the support 141a. One end of the shaft 143 is connected to the stepping motor 142, while the other end of the shaft 143 is rotatably supported by the support 141b.

As shown in FIG. 12, a connector 145 for the shaft 143 is provided on the inner reel 144. The driving power of the stepping motor 142 is transmitted through the shaft 143 to the inner reel 144. The outer reels 146 and 147 are supported by the shaft 143, but are not connected thereto, thereby being allowed to rotate separately from the shaft 143. The outer reels 146 and 147 are arranged so as to be each overlaid on approximately half the width of the inner reel 144. In this way, the structure of the mechanical reels realizes a half-width overlap between the display regions of the adjacent symbol sequences, and accordingly, the player can see the mechanical action of the mutually overlaid mechanical reels. The three-dimensional action can encourage the player's interest. Pulleys 148 and 149 which can be equipped with rotation belts (not shown in the drawing) are installed on the outer reels 146 and 147. Furthermore, two stepping motors (not shown in the drawing) can be provided on the outer reels 146 and 147 to transfer a motive force through the rotation belts.

The CPU, through the controls the stepping motors, performs a first stop control for matching the edges of the perimeters of the symbols between the inner reel 144 and one of the outer reels 146 and 147, and performs a second stop control for matching the vertices of the symbols between the two outer (or inner) reels.

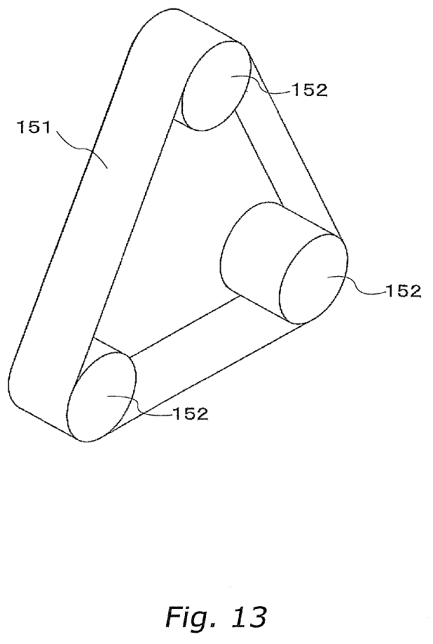

The mechanical reels may include multiple reels or a reel unit which rotates a reel belt 151 using three pulleys 152 such as shown in FIG. 13. The pulleys 152 are not limited to three, and there may be four or more. At least one of the pulleys 152 receives a motive force from a stepping motor not shown in the drawings. This mechanical reel game machine is only one example, and the present invention includes other modifications.

The perimeters or frames of the symbols may be other polygonal shapes, in contrast to a rhombus or an isosceles triangle in the above-described embodiments, insofar as the other polygonal shapes allow their edges to match each other between adjacent symbol sequences, and allow their vertices to match each other between two symbol sequences that are separated by one symbol sequence.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A game machine for determining whether to award a prize according to an arrangement of a plurality of symbols, the game machine comprising:
a display unit which displays a plurality of identical or different symbols, wherein the plurality of symbols are aligned in parallel symbol sequences, there is a half-width overlap between display regions of adjacent symbol sequences, and a perimeter or frame of each of the plurality of symbols forms a polygonal shape;
a start signal generating unit which generates a start signal;
a display control unit that executes a change control which continually switches the plurality of symbols displayed on the display unit upon receipt of the start signal, and thereafter executes a stop control which stops the change control; and
an award determination unit which determines whether or not to award at least one predetermined prize upon receipt of the start signal;
wherein when the award determination unit determines that the at least one predetermined prize is to be awarded, the display control unit executes a first stop control, in which the edges of the polygonal perimeters or frames of specific symbols included in two adjacent symbol sequences are matched with each other, and/or a second stop control in which the vertices of the polygonal perimeters or frames of specific symbols included in two symbol sequences that are separated by one symbol sequence are matched with each other.

2. The game machine of claim 1, further comprising:
a random number generating unit which generates a random number or a combination of random numbers upon receipt of the start signal; and
a storage unit which stores an award determination table, the award determination table establishing correspondences between the random number or the combination of random numbers and the award of the at least one predetermined prize;
wherein the award determination unit determines whether or not to award the at least one predetermined prize by referencing the random number or the combination of random numbers generated by the random number generating unit in the award determination table.

3. The game machine of claim 1, wherein the specific symbols in the two symbol sequences are the same symbols.

4. The game machine of claim 1, wherein the polygonal shape of the perimeter or frame of each of the plurality of symbols is a rhombus, and the direction of a diagonal line of the rhombus matches the direction of the symbol sequences.

5. The game machine of claim 1, wherein the polygonal shape of the perimeter or frame of each of the plurality of symbols is an isosceles triangle, and the direction of the bisector of the apex angle of the isosceles triangle matches the direction of the symbol sequences.

6. The game machine of claim 1, wherein the plurality of symbols are arranged on a plurality of parallel mechanical reels to form the symbol sequences, adjacent mechanical reels mutually overlap by half the width of each mechanical reel, and adjacent symbol sequences mutually overlap by half the width of each symbol sequence.

7. The game machine of claim 1, further comprising:
a storage unit which stores symbol arrangement data for the symbol sequences;
wherein the display control unit reads the symbol arrangement data from the storage unit and uses the data in order to perform the change control and the first and second stop controls.
